(19) United States
(12) Patent Application Publication
(10) Pub. No.: US 2025/0392460 A1
(43) Pub. Date: Dec. 25, 2025

(54) INFORMATION PROCESSING DEVICE, INFORMATION PROCESSING METHOD, AND INFORMATION PROCESSING PROGRAM

(71) Applicant: LY Corporation, Tokyo (JP)

(72) Inventors: Wataru OGAMI, Tokyo (JP); Hidehito GOMI, Tokyo (JP)

(21) Appl. No.: 19/187,854

(22) Filed: Apr. 23, 2025

(30) Foreign Application Priority Data
Jun. 20, 2024 (JP) 2024-099669

(51) Int. Cl. H04L 9/14

(52) U.S. Cl. CPC H04L 9/14

(57) ABSTRACT

An information processing device according to the present application is an information processing device that is an authentication server of FIDO, and includes: an authentication processing unit that authenticates a user to be authenticated using a FIDO public key corresponding to a FIDO private key used by the user to be authenticated; a sharing unit that shares the FIDO public key, which is not disclosed in principle to authentication servers other than an authentication server for which FIDO key registration has been performed, with another authentication server satisfying a predetermined condition; and a setting unit that sets an authenticator of the user to be authenticated to perform authentication with the above another authentication server using the FIDO public key.

### CROSS-REFERENCE TO RELATED APPLICATIONS

The present application claims priority to and incorporates by reference the entire contents of Japanese Patent Application No. 2024-099669 filed in Japan on Jun. 20, 2024.

### BACKGROUND OF THE INVENTION

### 1. Field of the Invention

The present invention relates to an information processing device, an information processing method, and an information processing program.

### 2. Description of the Related Art

A technique related to Fast Identity Online (FIDO) and using an authenticator is disclosed (see JP 2020-141331 A). However, in the above related art, the number of times of registration of a key for authentication of FIDO with respect to a plurality of relying parties (RPs) cannot be reduced.

### SUMMARY OF THE INVENTION

According to an aspect, an information processing device according to the present application is an information processing device that is an authentication server of FIDO, and includes: an authentication processing unit that authenticates a user to be authenticated using a FIDO public key corresponding to a FIDO private key used by the user to be authenticated; a sharing unit that shares the FIDO public key, which is not disclosed in principle to authentication servers other than an authentication server for which FIDO key registration has been performed, with an other authentication server satisfying a predetermined condition; and a setting unit that sets an authenticator of the user to be authenticated to perform authentication with the other authentication server using the FIDO public key.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an outline of a FIDO authentication system;

FIG. 2 is an explanatory diagram illustrating an outline of a FIDO authentication system using a passkey;

FIG. 3 is an explanatory diagram illustrating an outline of an information processing system according to an embodiment;

FIG. 4 is an explanatory diagram illustrating an outline of a case of group management on an RP side;

FIG. 5 is an explanatory diagram illustrating an outline of a case of group management on an authenticator side;

FIG. 6 is a diagram illustrating a configuration example of a terminal device according to the embodiment;

FIG. 7 is a diagram illustrating a configuration example of a server device according to the embodiment;

FIG. 8 is a flowchart illustrating a processing procedure according to the embodiment; and

FIG. 9 is a diagram illustrating an example of a hardware configuration.

### DETAILED DESCRIPTION OF THE PREFERRED EMBODIMENTS

Hereinafter, a mode (hereinafter, described as an “embodiment”) for implementing an information processing device, an information processing method, and an information processing program according to the present application will be described in detail with reference to the drawings. Note that the information processing device, the information processing method, and the information processing program according to the present application are not limited by the embodiment. In the following embodiment, the same parts are denoted by the same reference signs, and redundant description will be omitted.

### 1. Outline of Information Processing System

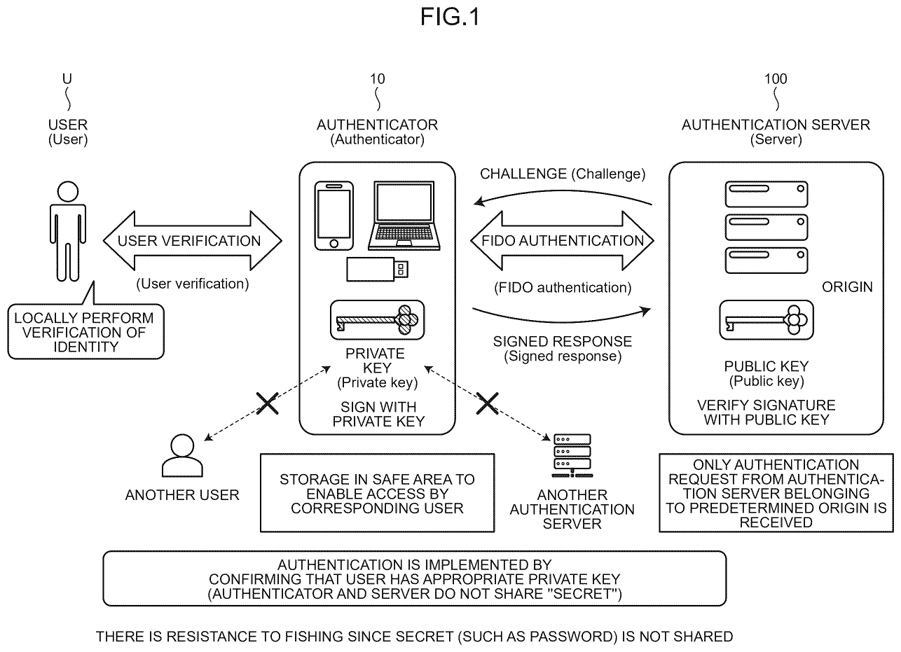

First, an outline of a FIDO authentication system will be described with reference to FIG. 1. FIG. 1 is an explanatory diagram illustrating the outline of the FIDO authentication system. Note that in FIG. 1, a basic mechanism of FIDO authentication will be described.

As illustrated in FIG. 1, the FIDO authentication system includes a terminal device 10 and a server device 100. The terminal device 10 and the server device 100 are connected to be capable of communicating with each other in a wired or wireless manner via a network. Thus, the terminal device 10 can federate with the server device 100. Examples of the network include a local area network (LAN), a wide area network (WAN), and/or the Internet.

The terminal device 10 is a smart device such as a smartphone or a tablet terminal used by a user U, and is a portable terminal device capable of communicating with any server device via a wireless communication network such as long term evolution (LTE), the fourth generation (4G), or the fifth generation (5G: the fifth generation mobile communication system), Bluetooth (registered trademark), a wireless LAN, or the like. In addition, the terminal device 10 includes a screen such as a liquid crystal display, the screen having a touch panel function, and receives various operations on display data such as content from the user U, such as a tap operation, a slide operation, and a scroll operation using a finger, a stylus, or the like. Note that an operation performed on a region of the screen where the content is displayed may be regarded as an operation on the content.

In addition, the terminal device 10 is not only a smart device but also a personal computer (PC) such as a desktop type or a notebook (laptop) type, a mobile phone such as a feature phone (a conventional flip-type mobile phone), a personal digital assistant (PDA), a game machine or AV equipment having a communication function, an information home appliance or a digital home appliance, a car navigation system, a wearable device such as a smart watch, a head-mounted display, or smart glasses, or the like. In addition, the terminal device 10 may be a house, a building, a car, a home appliance, electronic equipment, or the like compatible with Internet of Things (IOT).

In the present embodiment, the terminal device 10 functions as a FIDO client in FIDO authentication (Fast Identity Online). The FIDO client federates with an authenticator and performs user authentication. Note that the authenticator may be mounted on the same device as the FIDO client (built-in authenticator), or may be mounted on a device physically different from the FIDO client (external authenticator).

For example, in the FIDO authentication, an authentication scheme using storage or possessions such as a personal identification number (PIN), a universal serial bus (USB) security key, or a smart card, or an authentication scheme using biometric information or behavior information such as a fingerprint, a face, an iris, a vein, or a voiceprint can be implemented. The authentication schemes are not limited thereto, and any scheme may be introduced. In addition, multi-modal biometric authentication and multi-factor authentication can be achieved by combining a plurality of authentication schemes.

Hereinafter, for simplification of description, the terminal device 10 will be described as a FIDO client and an authenticator without distinguishing between the FIDO client and the authenticator. That is, a case where the authenticator is an internal authenticator will be described as an example. In practice, the authenticator may be an external authenticator that is physically independent from the terminal device 10 and can federate with the terminal device 10.

In addition, a web authentication application programming interface (API) for calling an authenticator from web content displayed on a web browser of a FIDO client and enabling the FIDO authentication by interacting with an authentication server can also be implemented, but the description thereof is omitted in the present embodiment.

Examples of the server device 100 include a computer such as a PC or a blade server, a mainframe, and a workstation. Note that the server device 100 may be implemented in cloud computing.

In the present embodiment, the server device 100 functions as an authentication server (FIDO server) in the FIDO authentication. The authentication server corresponds to a relying party (RP)/identity provider (IdP). A relying party (RP) refers to an entity or an organization on which the FIDO server is mounted. In the FIDO authentication, there is resistance to phishing since a “secret” such as a password or biometric information is not shared between an authenticator and the authentication server.

As illustrated in FIG. 1, in the FIDO authentication, the authentication server transmits a challenge to an authenticator on a user side when receiving an authentication request from the user. The challenge is a random character string that is valid only once, and is a data string that is determined based on a random number and is different every time. The user performs user verification using the authenticator, and locally performs verification of identity. Then, the authenticator signs a verification result with a private key, and transmits a signed response to the authentication server. When receiving the signed response, the authentication server performs signature verification using a public key. A pair of the private key and the public key is referred to as a key pair.

As described above, in the FIDO authentication, the authentication server uses the public key to confirm that the authenticator on the user side has an appropriate private key, thereby achieving the authentication. The authenticator and the authentication server do not share the “private key”.

In addition, the server device 100 also functions as a federated RP/SP (service provider) that provides an identity service by an ID federation with the RP/IdP corresponding to the FIDO authentication. When the FIDO authentication and the ID federation are combined, the context of authentication propagates from the authenticator through the RP/IdP to the federated RP/SP.

Hereinafter, for simplification of the description, the server device 100 will be described as an RP/IdP and a federated RP/SP without distinguishing between the RP/IdP and the federated RP/SP. In practice, a server device as the RP/IdP and a server device as the federated RP/SP may be different server devices physically independent of each other.

For example, the server device 100 may federate with the terminal device 10 of each user and provide an application programming interface (API) service for various applications (hereinafter, apps) and the like and various types of data to the terminal device 10 of each user.

In addition, the server device 100 may be an information processing device that provides some online services for the terminal device 10 of each user. For example, the server device 100 may provide, as the online services, services such as Internet connection, a search service, a social networking service (SNS), electronic commerce (EC), electronic payment, an online game, online banking, online trading, accommodation or ticket reservation, moving image or music distribution, news, a map, a route search, route guidance, route information, operation information, and weather forecast. In practice, the server device 100 may federate with various servers that provide the online service as described above to mediate the online services or to be in charge of processing the online services.

Note that the server device 100 can acquire user information regarding a user. For example, the server device 100 acquires, as the user information, information (attribute information) regarding attributes of the user such as the gender, age, and residential area of the user. In addition, the server device 100 can acquire information regarding attributes of the user, such as a demographic attribute, a psychographic attribute, a geographic attribute, and a behavioral attribute. In addition, the server device 100 may acquire, as the user information, a segment or a persona (figure) to which the user belongs in the field of marketing. Then, the server device 100 stores and manages the information (attribute information) regarding the attributes of the user together with identification information (a user ID and the like) indicating the user.

In addition, the server device 100 acquires various types of history information (log data) indicating behavior of the user from the terminal device 10 of the user or from various servers or the like based on the user ID and the like. For example, the server device 100 acquires, from the terminal device 10, a position history that is a history of a position of the user and date and time. In addition, the server device 100 acquires, from a search server (search engine), a search history that is a history of a search query input by the user. In addition, the server device 100 acquires, from a content server, a browsing history that is a history of content browsed by the user. In addition, the server device 100 acquires, from an EC server or a payment processing server, a purchase history (payment history) that is a history of product purchase and payment processing of the user. In addition, the server device 100 may acquire a selling history of a sales history, which is a history of selling of the user in a marketplace, from the EC server or the payment processing server. In addition, the server device 100 acquires a post history, which is a posting history of the user, from a posting server or an SNS server that provides a review posting service. Note that the above-described various servers and the like may be the server device 100 itself. That is, the server device 100 may function as the above-described various servers and the like.

In addition, the number of devices included in a information processing system 1 illustrated in FIG. 1 is not limited to the illustrated one. For example, FIG. 1 illustrates only one terminal device 10 for simplification of illustration, but this is merely an example, and two or more terminal devices may be provided without being limited thereto.

### 2. Sharing of Public Key Between RPs

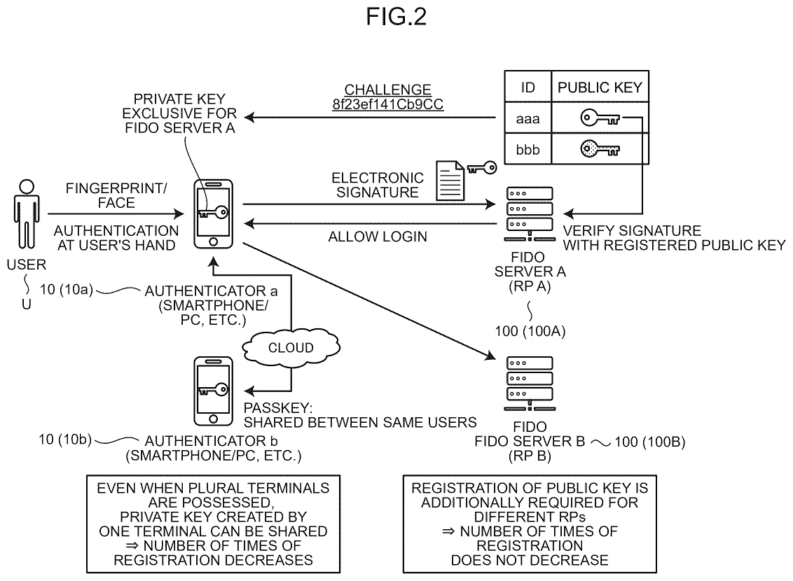

In recent years, convenience using a passkey has been improved in the FIDO authentication system. FIG. 2 is an explanatory diagram illustrating an outline of the FIDO authentication system using the passkey. As illustrated in FIG. 2, when the passkey is adopted, a private key created by one terminal can be shared with other terminals even when a user possesses a plurality of terminals, and thus, it is not necessary to register a key pair for authentication for each terminal of the same user with respect to the same relying party (RP), and the number of times of registration decreases.

However, a key for FIDO authentication is generated in association with an origin (generally, an Internet domain of a service), and thus, it is necessary to perform registration n times if there are n relying parties (RPs). As described above, the number of times of registration for different RPs does not decrease even if the passkey is used. That is, the passkey alone does not reduce the time and effort for the registration with respect to the plurality of RPs.

In addition, even if a public key (authentication key) for the FIDO authentication held by an RP is a “public key”, since the RP is used for user authentication, the public key is not allowed to be unconditionally disclosed and/or distributed to other RPs to be shared.

In addition, there is a case where even the same business operator is required to change the origin depending on circumstances. In addition, there is a case where origins are different although trust is established between RPs in a group company or the like. Alternatively, there is a case where origins are different for related services and the like although a user trusts both RPs equally. In FIDO specifications, RPs are different when origins are different.

In the present embodiment, a means for sharing a public key by a plurality of RPs is provided. Specifically, the concept of a passkey is also applied to a public key to enable the plurality of RPs to share the public key in an appropriate manner. For example, a public key for authentication is shared by mutual communication between RPs. It is an extended function from the FIDO specifications. Alternatively, since a password manager has a function of passing a password for a certain server to the other servers, a public key for the certain server is passed to the other servers using such a function.

### 2-1. Different Origins in Same Business Operator

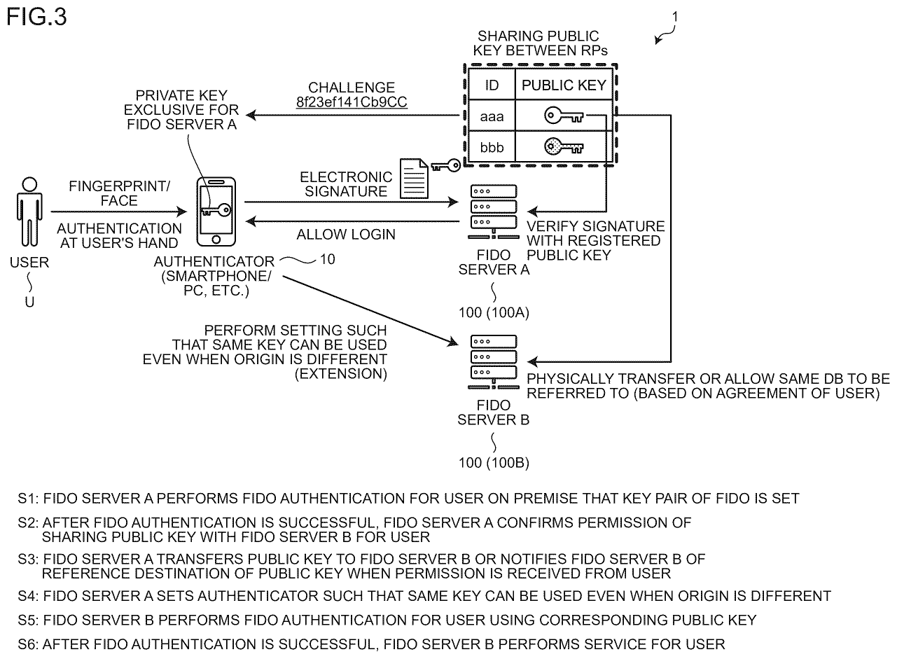

An outline of the information processing system according to the embodiment will be described with reference to FIG. 3. FIG. 3 is an explanatory diagram illustrating the outline of the information processing system according to the embodiment. Note that a case where origins are different in the same business operator will be described in FIG. 3.

As illustrated in FIG. 3, the information processing system 1 according to the embodiment includes the terminal device 10 of a user (user to be authenticated) that is an authenticator (and a FIDO client) in FIDO, and the server devices 100 that are relying parties (RPs) in FIDO. FIG. 3 illustrates, as an example, a server device 100A that is a FIDO server A (authentication server) and a server device 100B that is a FIDO server B (another authentication server) as the server devices 100. The FIDO server A is a FIDO server in which the user has registered a key. The FIDO server B is a (unregistered) FIDO server in which the user has not registered a key. The FIDO server A and the FIDO server B are server devices managed by the same business operator and have different origins. That is, in the server devices, trust is established between RPs.

For example, as illustrated in FIG. 3, the server device 100A that is the FIDO server A in which a key pair of FIDO is set performs FIDO authentication for the user (step S1). The FIDO authentication is performed according to normal FIDO specifications.

Next, when the FIDO authentication of the user is successful, the server device 100A that is the FIDO server A confirms, for the user, permission of sharing a public key with the FIDO server B for which trust is established between the RPs (step S2).

Next, when permission is received from the user, the server device 100A that is the FIDO server A transfers the public key to the server device 100B that is the FIDO server B or notifies the server device 100B of a reference destination of the public key (step S3). For example, the FIDO server A physically transfers the public key to the FIDO server B or allows the FIDO server B to refer to the same database (DB) storing the public key based on the user's agreement. At this time, the FIDO server A may perform access control (setting change) such that the FIDO server B can refer to the public key.

Next, the server device 100A that is the FIDO server A sets the terminal device 10, which is the authenticator of the user, such that the same key can be used even when an origin is different (step S4). This is an extended function different from the FIDO specifications. For example, the FIDO server A sets FIDO authentication information of the authenticator such that the same key can be used for a plurality of origins. Alternatively, the FIDO server A requests the authenticator to change only the origin and duplicate the FIDO authentication information. In practice, the authenticator may receive a notification from the FIDO server A that the public key of FIDO has been shared with the FIDO server B, and perform setting such that the same key can be used even when the origin is different.

Next, the server device 100B, which is the FIDO server B, performs FIDO authentication for the user using the transferred or notified public key (step S5).

Next, when the FIDO authentication of the user is successful, the server device 100B that is the FIDO server B performs a service for the user (step S6).

As described above, as compared with the case of using only a passkey, the number of times of registration can be further reduced by sharing the public key corresponding to the passkey in the present embodiment.

Note that only the server device 100B that is the FIDO server B has been described above, but the public key can be shared by FIDO servers other than the FIDO server B (other FIDO servers for which trust is established) in the same procedure as described above.

In addition, when a request for sharing (disclosing) the FIDO public key of the user is received from the FIDO server B, the FIDO server A may confirm permission of sharing the public key with the FIDO server B for the user.

### 2-2. Group Management on RP Side

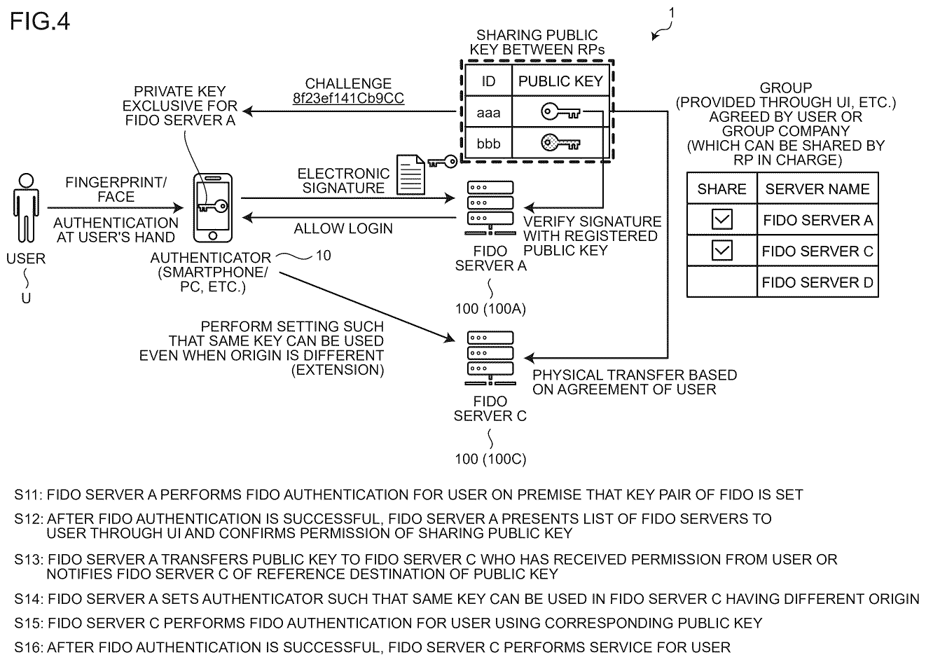

A case of group management on an RP side will be described with reference to FIG. 4. FIG. 4 is an explanatory diagram illustrating an outline of the case of group management on the RP side.

For example, as illustrated in FIG. 4, the server device 100A that is the FIDO server A in which a key pair of FIDO is set performs FIDO authentication for a user (step S11). The FIDO authentication is performed according to normal FIDO specifications.

Next, when the FIDO authentication of the user is successful, the server device 100A, which is the FIDO server A, presents a list (RP trust list) of FIDO servers, which are key sharing targets (candidates), to the user via a user interface (UI), and confirms permission of sharing of a public key to each of the FIDO servers on the list (step S12). It is assumed that the list (RP trust list) of FIDO servers is stored in the server device 100A that is the FIDO server A. Here, it is assumed that the permission of sharing the public key to a FIDO server C (another authentication server) is received separately from the FIDO server A (authentication server) that has already stored and used the public key.

Next, the server device 100A, which is the FIDO server A, transfers the public key to a server device 100C, which is the FIDO server C who has received the permission from the user, or notifies the FIDO server C of a reference destination of the public key (step S13).

Next, the server device 100A that is the FIDO server A sets the terminal device 10, which is the authenticator of the user, such that the same key can be used also in the FIDO server C having a different origin (step S14). In practice, the authenticator may receive a notification from the FIDO server A that the key has been shared with the FIDO server C, and perform setting such that the same key can be used also in the FIDO server C having the different origin.

Next, the server device 100C, which is the FIDO server C, performs FIDO authentication for the user using the transferred or notified public key (step S15).

Next, when the FIDO authentication of the user is successful, the server device 100C that is the FIDO server C performs a service for the user (step S16).

In practice, each of FIDO servers belonging to the same company group may hold a list of the FIDO servers of the group company in advance. It can be said that trust is established between RPs in the case of the group company. Then, when a user logs in to any of the FIDO servers belonging to the same company group by FIDO authentication, the list of FIDO servers of the group company may be presented so as to confirm permission of sharing of a public key with respect to each of the FIDO servers on the list.

### 2-3. Group Management on Authenticator Side

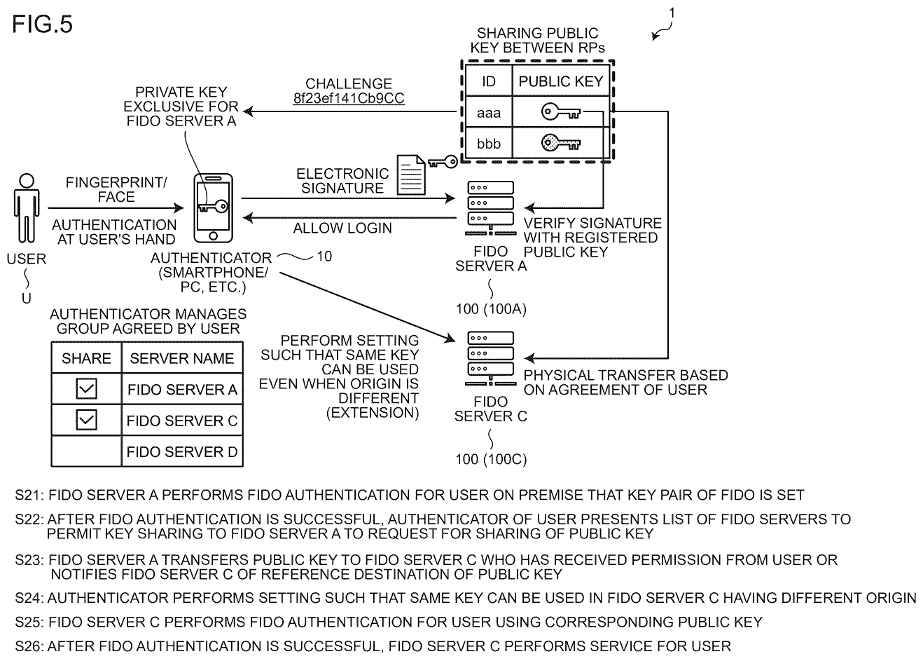

A case of group management on an authenticator side will be described with reference to FIG. 5. FIG. 5 is an explanatory diagram illustrating an outline of the case of group management on the authenticator side.

For example, as illustrated in FIG. 5, the server device 100A that is the FIDO server A in which a key pair of FIDO is set performs FIDO authentication for a user (step S21). The FIDO authentication is performed according to normal FIDO specifications.

Next, the terminal device 10 that is an authenticator of the user provides a list (user permission list) of FIDO servers, which are trusted by the user and permitted to share a public key, to the server device 100A that is the FIDO server A, and requests for sharing the public key with each of the FIDO servers on the list (step S22). It is assumed that the list (user permission list) of FIDO servers is stored in the terminal device 10 that is the authenticator of the user. Here, it is assumed that sharing of the public key with the FIDO server C is permitted separately from the FIDO server A that has already stored and used the public key.

Next, the server device 100A, which is the FIDO server A, transfers the public key to the server device 100C, which is the FIDO server C for which the user has permitted the key sharing, or notifies the FIDO server C of a reference destination of the public key (step S23). At this time, the FIDO server A may determine whether the FIDO server C is a reliable RP according to its own determination criterion. Then, only in a case where the FIDO server C is a reliable RP, the FIDO server A may transfer the public key to the FIDO server C or notify the FIDO server C of the reference destination of the public key. In addition, the FIDO server A may return, to the user, a response indicating that the public key has been shared with the server device 100C as a response to the request for sharing the public key. Note that, in a case where the FIDO server C is not a reliable RP, the FIDO server A may return, to the user, a response indicating that the sharing of the public key with respect to the FIDO server C is rejected together with the reason, and end the series of processing.

Next, the terminal device 10 that is the authenticator of the user receives a notification indicating that the key is shared with the FIDO server C from the server device 100A that is the FIDO server A, and performs setting such that the same key can be used also in the FIDO server C having a different origin (step S24). In practice, the FIDO server A may set the authenticator such that the same key can be used also in the FIDO server C having the different origin.

Next, the server device 100C, which is the FIDO server C, performs FIDO authentication for the user using the transferred or notified public key (step S25).

Next, when the FIDO authentication of the user is successful, the server device 100C that is the FIDO server C performs a service for the user (step S26).

In practice, the FIDO server A may request the authenticator of the user for a list (user permission list) of FIDO servers that are trusted by the user and are permitted to share the public key. Then, in response to the request for the list from the FIDO server A, the authenticator of the user may provide the FIDO server A with the list of FIDO servers that are trusted by the user and permitted to share the public key.

In addition, the FIDO server A may disclose the FIDO public key to the FIDO server C when a public request (sharing request) of the FIDO public key corresponding to a FIDO private key used for authenticating the user is received from the user or the FIDO server C. Note that the user's agreement is required to disclose the FIDO public key. Then, the FIDO server C authenticates the user using the FIDO public key corresponding to the FIDO private key used by the user.

### 3. Configuration Example of Terminal Device

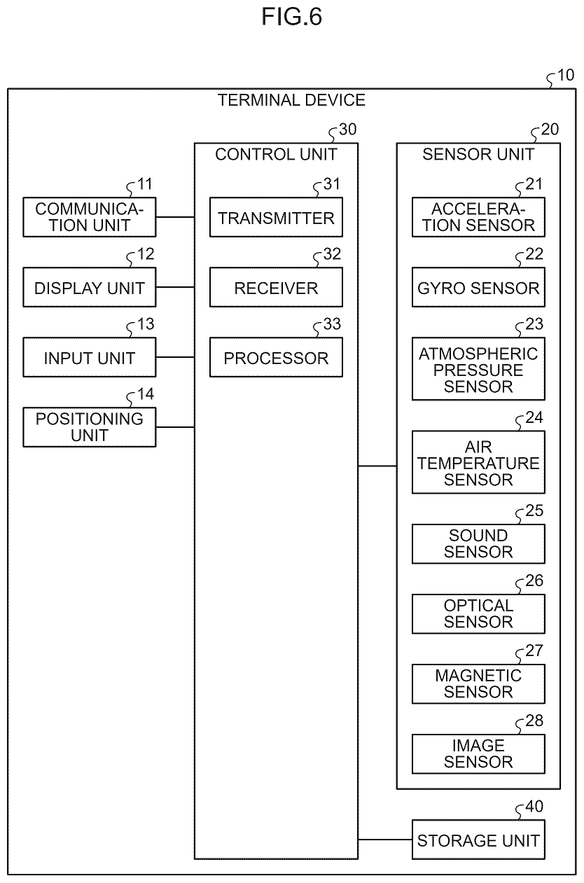

Next, a configuration of the terminal device 10 will be described with reference to FIG. 6. FIG. 6 is a diagram illustrating a configuration example of the terminal device 10 according to the embodiment. As illustrated in FIG. 6, the terminal device 10 includes a communication unit 11, a display unit 12, an input unit 13, a positioning unit 14, a sensor unit 20, a control unit 30 (controller), and a storage unit 40.

### Communication Unit 11

The communication unit 11 is connected to a network in a wired or wireless manner, and transmits and receives information to and from the server device 100 via the network. For example, the communication unit 11 is achieved by a network interface card (NIC), an antenna, or the like.

### Display Unit 12

The display unit 12 is a display device that displays various types of information such as position information. For example, the display unit 12 is a liquid crystal display (LCD) or an organic electro-luminescent display (organic EL display). In addition, the display unit 12 is a touch panel display, but is not limited thereto.

### Input Unit 13

The input unit 13 is an input device that receives various operations from the user U. For example, the input unit 13 includes buttons or the like for inputting characters, numbers, and the like. Note that the input unit 13 may be an input/output port (I/O port), a universal serial bus (USB) port, or the like. In addition, in a case where the display unit 12 is a touch panel display, a part of the display unit 12 functions as the input unit 13. In addition, the input unit 13 may be a microphone or the like that receives a voice input from the user U. The microphone may be wireless.

### Positioning Unit 14

The positioning unit 14 receives a signal (radio wave) transmitted from a satellite of a global positioning system (GPS), and acquires position information (for example, latitude and longitude) indicating a current position of the terminal device 10 that is the own device based on the received signal. That is, the positioning unit 14 measures the position of the terminal device 10. Note that the GPS is merely an example of a global navigation satellite system (GNSS).

In addition, the positioning unit 14 can measure the position by various methods other than the GPS. For example, as an auxiliary positioning unit configured for position correction or the like, the positioning unit 14 may measure the position using various communication functions of the terminal device 10 as follows.

### Wi-Fi Positioning

For example, the positioning unit 14 measures the position of the terminal device 10 using a Wi-Fi (registered trademark) communication function of the terminal device 10 or a communication network provided in each communication company. Specifically, the positioning unit 14 measures the position of the terminal device 10 by performing Wi-Fi communication or the like and measuring a distance to a nearby base station or access point.

### Beacon Positioning

In addition, the positioning unit 14 may measure the position using a Bluetooth (registered trademark) function of the terminal device 10. For example, the positioning unit 14 measures the position of the terminal device 10 by connecting to a beacon transmitter connected by the Bluetooth (registered trademark) function.

### Geomagnetic Positioning

In addition, the positioning unit 14 measures the position of the terminal device 10 based on a geomagnetic pattern of a structure measured in advance and a geomagnetic sensor included in the terminal device 10.

### RFID Positioning

In addition, for example, in a case where the terminal device 10 has a function of a radio frequency identification (RFID) tag equivalent to a contactless IC card used at a station ticket gate, a store, or the like or has a function of reading the RFID tag, a used position is recorded together with information on payment or the like made by the terminal device 10. The positioning unit 14 may measure the position of the terminal device 10 by acquiring such information. In addition, the position may be measured by an optical sensor, an infrared sensor, or the like included in the terminal device 10.

The positioning unit 14 may measure the position of the terminal device 10 using one or a combination of the positioning means described above as necessary.

### Sensor Unit 20

The sensor unit 20 includes various sensors mounted on or connected to the terminal device 10. Note that the connection may be a wired connection or a wireless connection. For example, the sensors may be detection devices other than the terminal device 10, such as a wearable device and a wireless device. In the example illustrated in FIG. 6, the sensor unit 20 includes an acceleration sensor 21, a gyro sensor 22, an atmospheric pressure sensor 23, an air temperature sensor 24, a sound sensor 25, an optical sensor 26, a magnetic sensor 27, and an image sensor (camera) 28.

Note that each of the sensors 21 to 28 described above is merely an example and is not limited thereto. That is, the sensor unit 20 may include some of the sensors 21 to 28, or may include other sensors such as a humidity sensor in addition to or instead of each of the sensors 21 to 28.

The acceleration sensor 21 is, for example, a three-axis acceleration sensor, and detects a physical movement of the terminal device 10 such as a moving direction, speed, and acceleration of the terminal device 10. The gyro sensor 22 detects a physical movement of the terminal device 10 such as an inclination in three axial directions based on angular velocity of the terminal device 10 and the like. The atmospheric pressure sensor 23 detects, for example, atmospheric pressure around the terminal device 10.

Since the terminal device 10 includes the acceleration sensor 21, the gyro sensor 22, the atmospheric pressure sensor 23, and the like described above, the position of the terminal device 10 can be measured using a technique such as pedestrian dead-reckoning (PDR) using each of these sensors 21 to 23 and the like. Thus, it is possible to acquire indoor position information that is difficult to acquire by a positioning system such as a GPS.

For example, the number of steps, a walking speed, and a walking distance can be calculated by a pedometer that uses the acceleration sensor 21. In addition, it is possible to know a traveling direction, a direction of the line of sight, and an inclination of a body of the user U using the gyro sensor 22. In addition, the altitude or a floor number at which the terminal device 10 of the user U exists can be known from the atmospheric pressure detected by the atmospheric pressure sensor 23.

The air temperature sensor 24 detects, for example, air temperature around the terminal device 10. The sound sensor 25 detects, for example, a sound around the terminal device 10. The optical sensor 26 detects illuminance around the terminal device 10. The magnetic sensor 27 detects, for example, geomagnetism around the terminal device 10. The image sensor 28 captures an image around the terminal device 10.

The atmospheric pressure sensor 23, the air temperature sensor 24, the sound sensor 25, and the optical sensor 26 detect the atmospheric pressure, the air temperature, the sound, and the illuminance, respectively, and the image sensor 28 captures the image of the surroundings, whereby an environment, a situation, and the like around the terminal device 10 can be detected. In addition, the accuracy of the position information of the terminal device 10 can be improved from the environment, situation, and the like around the terminal device 10.

### Control Unit 30

The control unit 30 includes, for example, a microcomputer including a central processing unit (CPU) or a micro processing unit (MPU), a read only memory (ROM), a RAM, an input/output port, and the like, and various circuits. In addition, the control unit 30 may include, for example, hardware such as an integrated circuit such as an application specific integrated circuit (ASIC) or a field programmable gate array (FPGA). The control unit 30 includes a transmitter 31, a receiver 32, and a processor 33.

### Transmitter 31

The transmitter 31 can transmit, for example, various types of information input by the user U using the input unit 13, various types of information detected by each of the sensors 21 to 28 mounted on or connected to the terminal device 10, the position information of the terminal device 10 measured by the positioning unit 14, and the like to the server device 100 via the communication unit 11.

### Receiver 32

The receiver 32 can receive various types of information provided from the server device 100 and requests for various types of information from the server device 100 via the communication unit 11.

### Processor 33

The processor 33 controls the entire terminal device 10 including the display unit 12 and the like. For example, the processor 33 can output various types of information transmitted by the transmitter 31 and various types of information from the server device 100 received by the receiver 32 to the display unit 12 for display.

### Storage Unit 40

The storage unit 40 is achieved by, for example, a semiconductor memory element such as a random access memory (RAM) or a flash memory, or a storage device such as a hard disk drive (HDD), a solid state drive (SSD), or an optical disk. The storage unit 40 stores various programs, various types of data, and the like.

### 4. Configuration Example of Server Device

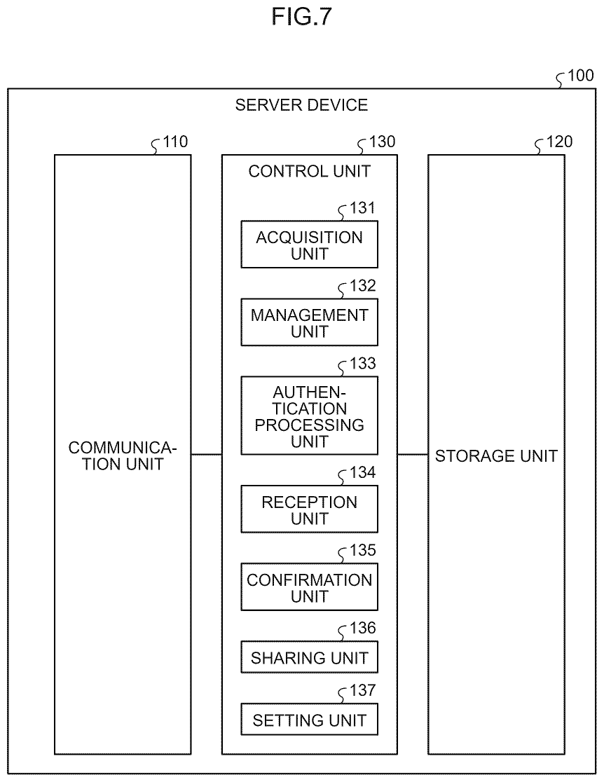

Next, a configuration of the server device 100 according to the embodiment will be described with reference to FIG. 7. FIG. 7 is a diagram illustrating a configuration example of the server device 100 according to the embodiment. As illustrated in FIG. 7, the server device 100 includes a communication unit 110, a storage unit 120, and a control unit 130.

### Communication Unit 110

The communication unit 110 is achieved by, for example, a network interface card (NIC) or the like. In addition, the communication unit 110 is connected to a network in a wired or wireless manner.

### Storage Unit 120

The storage unit 120 is achieved by, for example, a semiconductor memory element such as a random access memory (RAM) or a flash memory, or a storage device such as an HDD, an SSD, or an optical disk. The storage unit 120 may store attribute information and history information (log data) of the user U together with identification information (a user ID and the like) indicating the user U.

### Control Unit 130

The control unit 130 is a controller, and is achieved by, for example, a central processing unit (CPU), a micro processing unit (MPU), a graphics processing unit (GPU), an application specific integrated circuit (ASIC), a field programmable gate array (FPGA), or the like executing various programs (corresponding to an example of an information processing program) stored in a storage device inside the server device 100 using a storage area such as a RAM as a work area. In the example illustrated in FIG. 7, the control unit 130 includes an acquisition unit 131, a management unit 132, an authentication processing unit 133, a reception unit 134, a confirmation unit 135, a sharing unit 136, and a setting unit 137.

### Acquisition Unit 131

The acquisition unit 131 acquires a search query input by the user U. For example, when the user U inputs a search query to a search engine or the like and performs keyword search, the acquisition unit 131 acquires the search query via the communication unit 110. That is, the acquisition unit 131 acquires a keyword input to a search window of the search engine, a site, or an app by the user U via the communication unit 110.

In addition, the acquisition unit 131 acquires user information regarding the user U via the communication unit 110. For example, the acquisition unit 131 acquires identification information (a user ID or the like) indicating the user U, position information of the user U, attribute information of the user U, and the like from the terminal device 10 of the user U. In addition, the acquisition unit 131 may acquire the identification information indicating the user U, the attribute information of the user U, and the like during user registration of the user U. Then, the acquisition unit 131 stores the user information in the storage unit 120.

In addition, the acquisition unit 131 acquires various types of history information (log data) indicating behavior of the user U via the communication unit 110. For example, the acquisition unit 131 acquires various types of history information indicating the behavior of the user U from the terminal device 10 of the user U or from various servers or the like based on the user ID or the like. Then, the acquisition unit 131 stores the various types of history information in the storage unit 120.

In addition, the acquisition unit 131 acquires, from a user to be authenticated, a list of other authentication servers (other FIDO servers) which are trusted by the user U who is the user to be authenticated and permitted to share a FIDO public key. For example, the acquisition unit 131 acquires the list of other authentication servers held by the terminal device 10 from the terminal device 10 of the user U serving as an authenticator of the user to be authenticated via the communication unit 110.

### Management Unit 132

The management unit 132 manages the list of other authentication servers with which the FIDO public key is to be shared. For example, the management unit 132 manages the list of other authentication servers trusted by the server device 100 that is an authentication server in a group company or the like. In addition, the management unit 132 may manage the list of other authentication servers acquired from the terminal device 10 of the user U serving as the authenticator of the user to be authenticated. In addition, the management unit 132 may manage the FIDO public key in cooperation with the storage unit 120.

### Authentication Processing Unit 133

The authentication processing unit 133 authenticates the user to be authenticated using the FIDO public key corresponding to a FIDO private key used by the user U who is the user to be authenticated. That is, the authentication processing unit 133 performs the authentication by FIDO.

### Reception Unit 134

The reception unit 134 receives a request for sharing the FIDO public key between an authentication server (authentication server having the FIDO public key) and another authentication server (authentication server not having the FIDO public key) from the user to be authenticated or the above another authentication server. Note that the reception unit 134 may be common to the above-described acquisition unit 131.

### Confirmation Unit 135

Before sharing the FIDO public key with another authentication server, the confirmation unit 135 performs confirmation by inquiring of the user to be authenticated whether to agree to share the FIDO public key between the authentication server and the above another authentication server. For example, the confirmation unit 135 performs confirmation by inquiring of the terminal device 10 of the user U serving as the authenticator of the user to be authenticated via the communication unit 110 whether to agree to share the FIDO public key between the authentication server and the above another authentication server.

### Sharing Unit 136

The sharing unit 136 shares the FIDO public key, which is not disclosed in principle to authentication servers other than an authentication server for which FIDO key registration has been performed, with another authentication server satisfying a predetermined condition. Note that the above another authentication server satisfying the predetermined condition is another authentication server determined to be sufficiently reliable by at least the authentication server having the FIDO public key. Examples thereof include other authentication servers belonging to the same company group as the authentication server, other authentication servers trusted by the authentication server, and other authentication servers trusted by the user to be authenticated. Note that a condition for determining whether to trust the above another authentication server can be set in any manner by the authentication server having the FIDO public key.

For example, the sharing unit 136 provides (physically transfers) the FIDO public key to the above another authentication server. Alternatively, the sharing unit 136 notifies the above another authentication server of a location (reference destination) of the FIDO public key. Alternatively, the sharing unit 136 stores the FIDO public key in a predetermined storage place and discloses the storage place to the above another authentication server to allow the above another authentication server to access the FIDO public key.

Note that the sharing unit 136 shares the FIDO public key with the above another authentication server when the user to be authenticated agrees to share the FIDO public key between the authentication server and the above another authentication server.

In addition, the sharing unit 136 shares the FIDO public key with the above another authentication server when a request for sharing the FIDO public key between the authentication server and the above another authentication server is received from the user to be authenticated or the above another authentication server.

### Setting Unit 137

The setting unit 137 sets the authenticator of the user to be authenticated so as to perform authentication using the FIDO public key between the authenticator and another authentication server. For example, the setting unit 137 sets the terminal device 10 of the user U serving as the authenticator of the user to be authenticated via the communication unit 110 such that the same key can be used even when an origin is different.

### 5. Processing Procedure

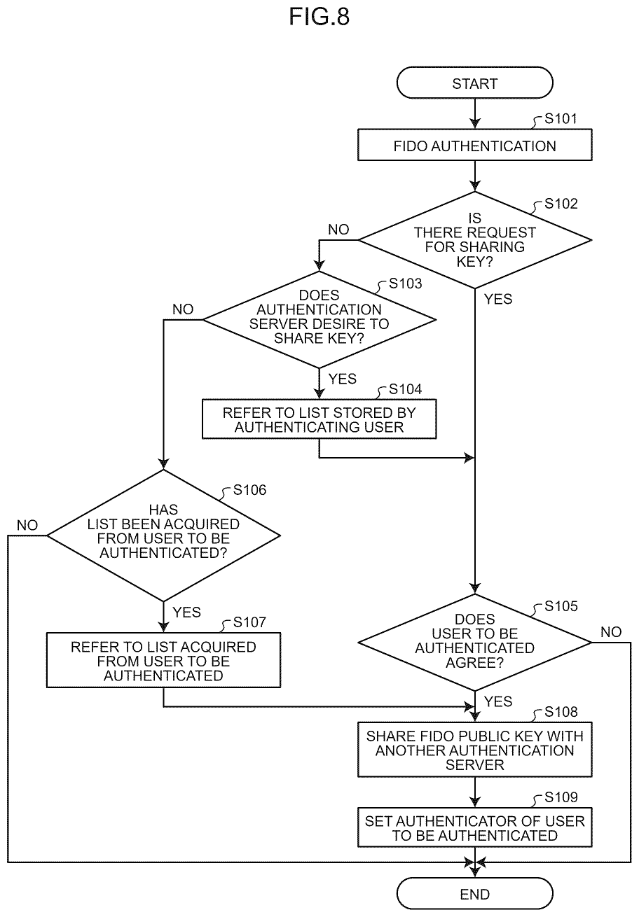

Next, a processing procedure by the server device 100 according to the embodiment will be described with reference to FIG. 8. FIG. 8 is a flowchart illustrating the processing procedure according to the embodiment. Note that the following processing procedure is repeatedly executed by the control unit 130 of the server device 100.

For example, as illustrated in FIG. 8, the authentication processing unit 133 of the server device 100 that is an authentication server of FIDO communicates with the terminal device 10 of the user U serving as an authenticator of a user to be authenticated via the communication unit 110, and authenticates the user to be authenticated using a FIDO public key corresponding to a FIDO private key used by the user U that is the user to be authenticated (step S101).

In addition, the sharing unit 136 of the server device 100 confirms whether the reception unit 134 has received a request for sharing the FIDO public key between the authentication server and another authentication server from the user to be authenticated or the above another authentication server via the communication unit 110 (step S102). When the request for sharing the FIDO public key is received (step S102; Yes), the processing transitions to step S105. Conversely, when there is no request for sharing the FIDO public key (step S102; No), the processing transitions to step S103.

In addition, the sharing unit 136 of the server device 100 confirms whether the authentication server desires to share the FIDO public key with the above another authentication server (step S103). When the authentication server desires to share the FIDO public key with the above another authentication server (step S103; Yes), the processing transitions to step S104. Conversely, when the authentication server does not desire to share the FIDO public key with the above another authentication server (step S103; No), the processing transitions to step S106.

Subsequently, the confirmation unit 135 of the server device 100 refers to a list that is stored by the management unit 132 and that is a list of other authentication servers with which the FIDO public key is to be shared (step S104).

Subsequently, the confirmation unit 135 of the server device 100 performs confirmation by inquiring of the terminal device 10 of the user U serving as the authenticator of the user to be authenticated via the communication unit 110 whether the user to be authenticated agrees to share the FIDO public key between the authentication server and the above another authentication server (step S105). At this time, the confirmation unit 135 may present the list of other authentication servers (or the other authentication servers listed in the list) stored in the management unit 132 to the terminal device 10 of the user U serving as the authenticator of the user to be authenticated, and confirm whether to agree to key sharing with each of the other authentication servers. When the user to be authenticated agrees to share the FIDO public key between the authentication server and the above another authentication server (step S105; Yes), the processing transitions to step S108. Conversely, when the user to be authenticated does not agree to share the FIDO public key between the authentication server and the above another authentication server (step S105; No), the series of processing is ended.

Alternatively, the sharing unit 136 of the server device 100 confirms whether the acquisition unit 131 has acquired, from the terminal device 10 of the user U serving as the authenticator of the user to be authenticated via the communication unit 110, a list of other authentication servers which are trusted by the user U that is the user to be authenticated and permitted to share the FIDO public key (step S106). When the list of other authentication servers has been acquired from the terminal device 10 of the user U (step S106; Yes), the sharing unit 136 refers to the acquired list of other authentication servers (step S107). Note that, when the list of other authentication servers has been acquired from the user to be authenticated, it is determined that the user to be authenticated has agreed with key sharing with the other authentication servers listed in the list. Conversely, when the list of other authentication servers has not been acquired from the terminal device 10 of the user U (step S106; No), the series of processing is ended.

Subsequently, based on the list of other authentication servers, the sharing unit 136 of the server device 100 shares the FIDO public key, which is not disclosed in principle to authentication servers other than an authentication server for which FIDO key registration has been performed, with another authentication server permitted to share the key (step S108).

Subsequently, the setting unit 137 of the server device 100 sets the terminal device 10 of the user U serving as the authenticator of the user to be authenticated via the communication unit 110 so as to perform authentication with the above another authentication server using the FIDO public key (step S109).

Thus, another authentication server can set the user to be authenticated using the FIDO public key.

### 6. Modifications

The terminal device 10 and the server device 100 described above may be implemented in various different modes other than the above embodiment. Therefore, modifications of the embodiment will be described below.

In the above embodiment, a part or a whole of the processing executed by the server device 100 may actually be executed by the terminal device 10 (or an app operating on the terminal device 10). For example, the processing may be completed in a stand-alone manner (by the terminal device 10 alone). In addition, there is also a technique in which the terminal device 10 performs authentication with another authenticator on behalf of a FIDO server and notifies the FIDO server of an authentication result. In this case, it is assumed that the terminal device 10 has the function of the server device 100 in the above embodiment. In addition, since the terminal device 10 federates with the server device 100 in the above embodiment, it seems that the terminal device 10 also executes the processing of the server device 100 from the viewpoint of the user U. That is, it can be said that the terminal device 10 includes the server device 100 from another viewpoint.

In addition, the list of other authentication servers (other FIDO servers) with which trust is established with the authentication server or the user to be authenticated may be stored in a database or a server on a network in the above embodiment. Then, the authentication server may acquire the list of other authentication servers from the network as necessary.

In addition, the authentication server (FIDO server) sharing the FIDO public key with another authentication server may also share another FIDO public key held by the above another authentication server in the above embodiment. That is, the FIDO servers that establish mutual trust may share the currently held FIDO public keys with each other.

In addition, in the above embodiment, the terminal device 10 of the user U serving as the authenticator of the user to be authenticated may be set such that the same key can be used even when an origin is different at a point in time when the user U agrees to share the FIDO public key between the authentication server and the other authentication server by a function of an app or the like. For example, when the user U agrees to share the FIDO public key between the authentication server and the other authentication server, the terminal device 10 of the user U may change the FIDO authentication information such that authentication is performed with the same key pair for authentication as that between the user to be authenticated and the authentication server also between the user to be authenticated and the above another authentication server by using the agreement as a trigger.

### 7. Effects

As described above, an information processing device (the terminal device 10 and the server device 100) according to the present application is an information processing device that is an authentication server of FIDO, and includes: the authentication processing unit 133 that authenticates a user to be authenticated (user) using a FIDO public key corresponding to a FIDO private key used by the user to be authenticated; the sharing unit 136 that shares the FIDO public key, which is not disclosed in principle to authentication servers other than an authentication server for which FIDO key registration has been performed, with another authentication server satisfying a predetermined condition; and the setting unit 137 that sets an authenticator of the user to be authenticated to perform authentication with the above another authentication server using the FIDO public key.

The sharing unit 136 provides the FIDO public key to the above another authentication server.

Alternatively, the sharing unit 136 notifies the above another authentication server of a location of the FIDO public key.

Alternatively, the sharing unit 136 stores the FIDO public key in a predetermined storage place and discloses the storage place to the above another authentication server to allow the above another authentication server to access the FIDO public key.

In addition, the information processing device according to the present application further includes the confirmation unit 135 that performs confirmation by inquiring of the user to be authenticated whether to agree to share the FIDO public key between the authentication server and the above another authentication server before sharing the FIDO public key with the above another authentication server. The sharing unit 136 shares the FIDO public key with the above another authentication server when the user to be authenticated agrees to share the FIDO public key between the authentication server and the above another authentication server.

In addition, the information processing device according to the present application further includes the reception unit 134 that receives a request for sharing the FIDO public key between the authentication server and the above another authentication server from the user to be authenticated or the above another authentication server. The sharing unit 136 shares the FIDO public key with the above another authentication server when the request for sharing the FIDO public key between the authentication server and the above another authentication server is received from the user to be authenticated or the above another authentication server.

In addition, the information processing device according to the present application further includes the management unit 132 that manages a list of the other authentication servers with which the FIDO public key is to be shared.

In addition, the information processing device according to the present application further includes an acquisition unit that acquires, from the user to be authenticated, a list of the other authentication servers which are trusted by the user to be authenticated and permitted to share the FIDO public key.

With any one or a combination of the above-described processes, the information processing device according to the present application can reduce the number of times of registration of a key for authentication of FIDO with respect to a plurality of RPs.

### 8. Hardware Configuration

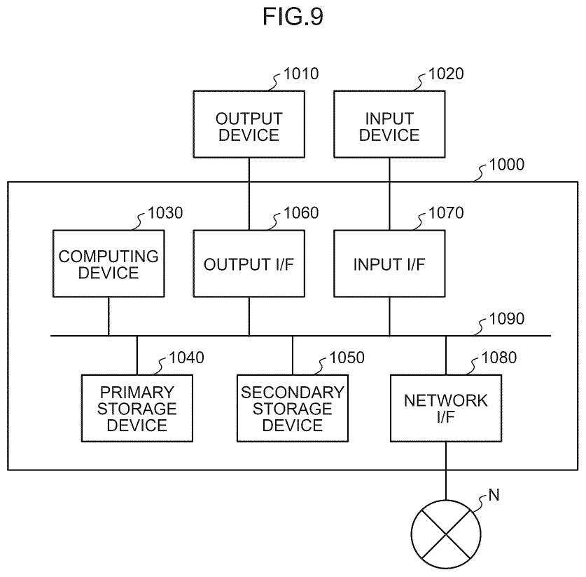

In addition, the terminal device 10 and the server device 100 according to the above embodiment are achieved by, for example, a computer 1000 having a configuration as illustrated in FIG. 9. Hereinafter, the server device 100 will be described as an example. FIG. 9 is a diagram illustrating an example of a hardware configuration. The computer 1000 is connected to an output device 1010 and an input device 1020, and has a mode in which a computing device 1030, a primary storage device 1040, a secondary storage device 1050, an output interface (I/F) 1060, an input I/F 1070, and a network I/F 1080 are connected by a bus 1090.

The computing device 1030 operates based on a program stored in the primary storage device 1040 or the secondary storage device 1050, a program read from the input device 1020, or the like, and executes various processes. The computing device 1030 is achieved by, for example, a central processing unit (CPU), a micro processing unit (MPU), a graphics processing unit (GPU), an application specific integrated circuit (ASIC), a field programmable gate array (FPGA), or the like.

The primary storage device 1040 is a memory device, such as a random access memory (RAM), which temporarily stores data used for various arithmetic operations by the computing device 1030. In addition, the secondary storage device 1050 is a storage device in which data used for various arithmetic operations by the computing device 1030 and various types of databases are registered, and is achieved by a read only memory (ROM), a hard disk drive (HDD), a solid state drive (SSD), a flash memory, or the like. The secondary storage device 1050 may be a built-in storage or an external storage. In addition, the secondary storage device 1050 may be a removable storage medium such as a universal serial bus (USB) memory or a secure digital (SD) memory card. In addition, the secondary storage device 1050 may be a cloud storage (online storage), a network attached storage (NAS), a file server, or the like.

The output I/F 1060 is an interface for transmitting information to be output to the output device 1010 that outputs various types of information, such as a display, a projector, or a printer, and is achieved by, for example, a connector of a standard such as a universal serial bus (USB), a digital visual interface (DVI), or a high definition multimedia interface (HDMI) (registered trademark). In addition, the input I/F 1070 is an interface for receiving information from various input devices 1020 such as a mouse, a keyboard, a keypad, a button, and a scanner, and is achieved by, for example, a USB or the like.

In addition, the output I/F 1060 and the input I/F 1070 may be wirelessly connected to the output device 1010 and the input device 1020, respectively. That is, the output device 1010 and the input device 1020 may be wireless equipment.

In addition, the output device 1010 and the input device 1020 may be integrated like a touch panel. In this case, the output I/F 1060 and the input I/F 1070 may also be integrated as an input/output I/F.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like.

In addition, the network I/F 1080 receives data from another equipment via a network and transmits the data to the computing device 1030, and transmits data generated by the computing device 1030 to another equipment via the network.

The computing device 1030 controls the output device 1010 and the input device 1020 via the output I/F 1060 and the input I/F 1070. For example, the computing device 1030 loads a program from the input device 1020 or the secondary storage device 1050 onto the primary storage device 1040 and executes the loaded program.

For example, in a case where the computer 1000 functions as the server device 100, the computing device 1030 of the computer 1000 achieves the function of the control unit 130 by executing a program loaded on the primary storage device 1040. In addition, the computing device 1030 of the computer 1000 may load a program acquired from another equipment via the network I/F 1080 onto the primary storage device 1040 and execute the loaded program. In addition, the computing device 1030 of the computer 1000 may cooperate with another equipment via the network I/F 1080, and may call a function, data, and the like of a program from another program of the other equipment to use.

### 9. Others

Although the embodiment of the present application has been described above, the present invention is not limited by the content of the embodiment. In addition, the above-described constituent elements include one that can be easily assumed by those skilled in the art, one that is substantially the same, and one in a so-called equivalent range. Furthermore, the above-described constituent elements can be appropriately combined. Furthermore, various omissions, substitutions, or changes of the constituent elements can be made within a scope not departing from the gist of the above embodiment.

Among the processes described in the above embodiment, all or some of the processes described as being performed automatically can be performed manually, or all or some of the processes described as being performed manually can be performed automatically by a known method. In addition, the processing procedure, specific names, and information including various types of data and parameters illustrated in the document and the drawings can be changed in any manner unless otherwise specified. For example, various types of information illustrated in each drawing are not limited to the illustrated information.

In addition, each constituent element of each illustrated device illustrated in the drawings is functionally conceptual, and is not necessarily physically configured as illustrated in the drawings. That is, specific modes of distribution and integration of the respective devices are not limited to those illustrated in the drawings, and some or all of the devices may be functionally or physically distributed or integrated in any unit according to, for example, various types of load or use conditions.

For example, the above-described server device 100 may be achieved by a plurality of server computers, and the configuration can be flexibly changed such that an external platform or the like is called and achieved by an application programming interface (API), network computing, or the like depending on functions.

In addition, the above embodiment and modifications can be appropriately combined within a range in which the content of processing is consistently maintained.

In addition, the “section, module, or unit” described above can be read as a “means”, a “circuit”, or the like. For example, the acquisition unit can be replaced with an acquisition means or an acquisition circuit.

According to an aspect of an embodiment, it is possible to reduce the number of times of registration of a key for authentication of FIDO for a plurality of RPs.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device that is an authentication server of FIDO, the information processing device comprising:
an authentication processing unit that authenticates a user to be authenticated using a FIDO public key corresponding to a FIDO private key used by the user to be authenticated;
a sharing unit that shares the FIDO public key, which is not disclosed in principle to authentication servers other than an authentication server for which FIDO key registration has been performed, with another authentication server satisfying a predetermined condition; and
a setting unit that sets an authenticator of the user to be authenticated to perform authentication with the above another authentication server using the FIDO public key.

2. The information processing device according to claim 1, wherein
the sharing unit provides the FIDO public key to the above another authentication server.

3. The information processing device according to claim 1, wherein
the sharing unit notifies the above another authentication server of a location of the FIDO public key.

4. The information processing device according to claim 1, wherein
the sharing unit stores the FIDO public key in a predetermined storage place and discloses the storage place to the above another authentication server to allow the above another authentication server to access the FIDO public key.

5. The information processing device according to claim 1, further comprising
a confirmation unit that performs confirmation by inquiring of the user to be authenticated whether to agree to share the FIDO public key between the authentication server and the above another authentication server before sharing the FIDO public key with the above another authentication server, wherein
the sharing unit shares the FIDO public key with the above another authentication server when the user to be authenticated agrees to share the FIDO public key between the authentication server and the above another authentication server.

6. The information processing device according to claim 1, further comprising
a reception unit that receives a request for sharing the FIDO public key between the authentication server and the above another authentication server from the user to be authenticated or the above another authentication server, wherein
the sharing unit shares the FIDO public key with the above another authentication server when the request for sharing the FIDO public key between the authentication server and the above another authentication server is received from the user to be authenticated or the above another authentication server.

7. The information processing device according to claim 1, further comprising
a management unit that manages a list of the other authentication servers with which the FIDO public key is to be shared.

8. The information processing device according to claim 1, further comprising
an acquisition unit configured to acquire, from the user to be authenticated, a list of the other authentication servers which are trusted by the user to be authenticated and permitted to share the FIDO public key.

9. An information processing method executed by an information processing device that is an authentication server of FIDO, the information processing method comprising:
an authentication step of authenticating a user to be authenticated using a FIDO public key corresponding to a FIDO private key used by the user to be authenticated;
a sharing step of sharing the FIDO public key, which is not disclosed in principle to authentication servers other than an authentication server for which FIDO key registration has been performed, with another authentication server satisfying a predetermined condition; and
a setting step of setting an authenticator of the user to be authenticated to perform authentication with the above another authentication server using the FIDO public key.

10. A non-transitory computer readable storage medium storing an information processing program for causing a computer that is an authentication server of FIDO to execute:
an authentication procedure of authenticating a user to be authenticated using a FIDO public key corresponding to a FIDO private key used by the user to be authenticated;
a sharing procedure of sharing the FIDO public key, which is not disclosed in principle to authentication servers other than an authentication server for which FIDO key registration has been performed, with another authentication server satisfying a predetermined condition; and
a setting procedure of setting an authenticator of the user to be authenticated to perform authentication with the above another authentication server using the FIDO public key.
